(19) United States
(12) Patent Application Publication
(10) Pub. No.: US 2026/0253795 A1
(43) Pub. Date: Aug. 27, 2026

(54) MULTILAYER CERAMIC CAPACITOR

(71) Applicant: Murata Manufacturing Co., Ltd., Nagaokakyo-shi (JP)

(72) Inventor: Takashi DEGURA, Nagaokakyo-shi (JP)

(21) Appl. No.: 19/654,888

(22) Filed: Apr. 22, 2026

Related U.S. Application Data
(63) Continuation of application No. PCT/JP2024/040252, filed on Nov. 13, 2024.

(30) Foreign Application Priority Data
Apr. 10, 2024 (JP) 2024-063407

(51) Int. Cl. H01G 4/005; H01G 4/12; H01G 4/252; H01G 4/30

(52) U.S. Cl. CPC H01G 4/005; H01G 4/1236; H01G 4/252; H01G 4/30

(57) ABSTRACT

In a multilayer ceramic capacitor, dielectric layers include at least one of TiO₂ and (Ca_{1-x-y}, Srₓ, Ba_{y})ₘ(Zr_{1-z-α}, Ti_{z})O₃, where x is about 0 or more and about 1 or less, y is about 0 or more and about 0.4 or less, m is about 1.0 or more and about 1.1 or less, z is about 0 or more and about 0.2 or less, and α is about 0 or more and about 0.3 or less. A ratio of a length of a boundary defined by straight lines and a length of an actual boundary between an inner electrode layer and a dielectric layer. A thickness of an end portion of the inner electrode layer is about 1.2 μm or more. A coverage of the end portion is greater than a coverage of a middle portion of the inner electrode layer. An average particle diameter of copper in the inner electrode layer is about 2.2 μm or more.

### CROSS REFERENCE TO RELATED APPLICATIONS

This application claims the benefit of priority to Japanese Patent Application No. 2024-063407 filed on Apr. 10, 2024 and is a Continuation Application of PCT Application No. PCT/JP2024/040252 filed on Nov. 13, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Electronic devices equipped with a high-frequency circuit demand multilayer ceramic capacitors that can provide a high Q-value in a high-frequency region. Japanese Unexamined Patent Application Publication No. 2000-306762 discloses a technique of increasing the thicknesses of inner electrodes and thereby increasing the Q-value of a multilayer ceramic capacitor in a high-frequency region.

### SUMMARY OF THE INVENTION

In a high-frequency region, electric conduction is predominant in the vicinity of the surfaces of an inner electrode. This is due to the skin effect. Accordingly, the Q-value does not improve remarkably, for example, by increasing the thickness of the inner electrode because an increase in the thickness does not contribute much to the increase of the surface area of the inner electrode.

Example embodiments of the present invention provide multilayer ceramic capacitors that each achieve a high Q-value.

A multilayer ceramic capacitor according to an example embodiment of the present invention includes a multilayer body in which multiple dielectric layers and multiple inner electrode layers are laminated in a lamination direction. The dielectric layers include at least one of TiO₂ and (Ca_{1-x-y}, Srₓ, Ba_{y})ₘ(Zr_{1-z-α}, Ti_{z})O₃, where x is about 0 or more and about 1 or less, y is about 0 or more and about 0.4 or less, m is about 1.0 or more and about 1.1 or less, z is about 0 or more and about 0.2 or less, and α is about 0 or more and about 0.3 or less. When the multilayer body is cut along a cross section extending orthogonally to a lamination direction of the multilayer body to expose an inner electrode layer, the inner electrode layer includes widthwise end portions facing oppositely in a width direction of the inner electrode layer. When a shape of the inner electrode layer is regarded as a polygon as viewed in plan in the lamination direction and S denotes a length of a boundary defined by straight lines between the inner electrode layer and a dielectric layer and when A denotes a length of an actual boundary between the inner electrode layer and the dielectric layer, a ratio of the length A to the length S is about 1.7 or less. A thickness of a widthwise end portion of the inner electrode layer is about 1.2 μm or more. A coverage of the widthwise end portion of the inner electrode layer is greater than a coverage of a widthwise middle portion of the inner electrode layer. An average particle diameter of copper included in the inner electrode layer is about 2.2 μm or more.

According to example embodiments of the present invention, multilayer ceramic capacitors each achieve a high Q-value.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a multilayer ceramic capacitor according to an example embodiment of the present invention.

FIG. 2 is a cross-sectional view taken along line 201 -201 in FIG. 1.

FIG. 3 is a cross-sectional view taken along line 202 -202 in FIG. 1.

FIG. 4 is a cross-sectional view taken along line 203 -203 in FIG. 1.

FIG. 5 is an enlarged view illustrating first enclosed area 111 in FIG. 4.

FIG. 6 illustrates an LT cross section of a widthwise end portion of an inner electrode layer.

FIG. 7 illustrates an LT cross section of a widthwise middle portion of an inner electrode layer.

FIG. 8 illustrates an LW cross section of the multilayer ceramic capacitor.

### DETAILED DESCRIPTION OF THE EXAMPLE EMBODIMENTS

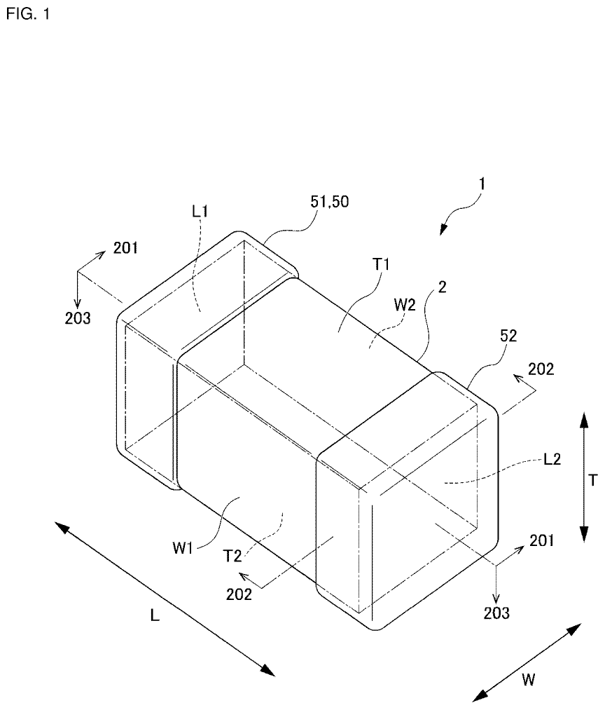

Multilayer ceramic capacitors according to example embodiments of the present invention are described below. FIG. 1 is a perspective view illustrating a multilayer ceramic capacitor 1 according to a present example embodiment of the present invention. As illustrated in FIG. 1, the multilayer ceramic capacitor 1 includes a multilayer body 2 and outer electrodes 50. The outer electrodes 50 include a first outer electrode 51 and a second outer electrode 52.

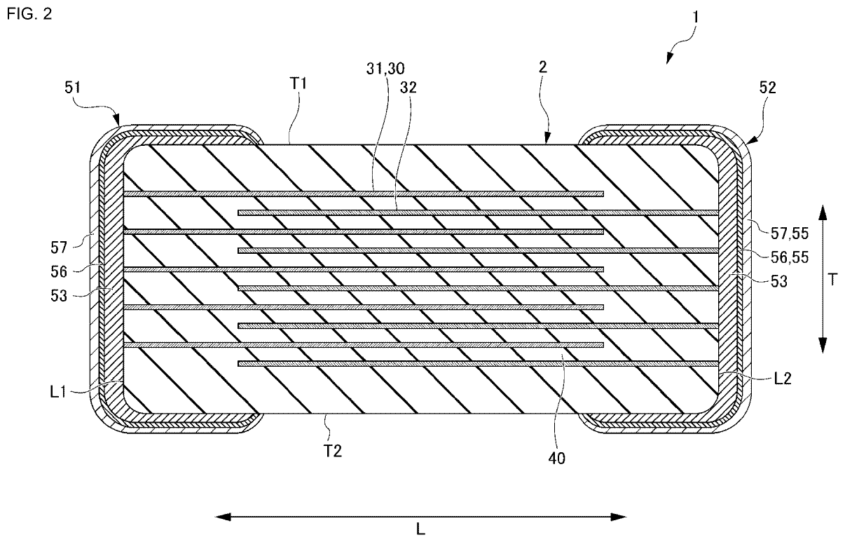

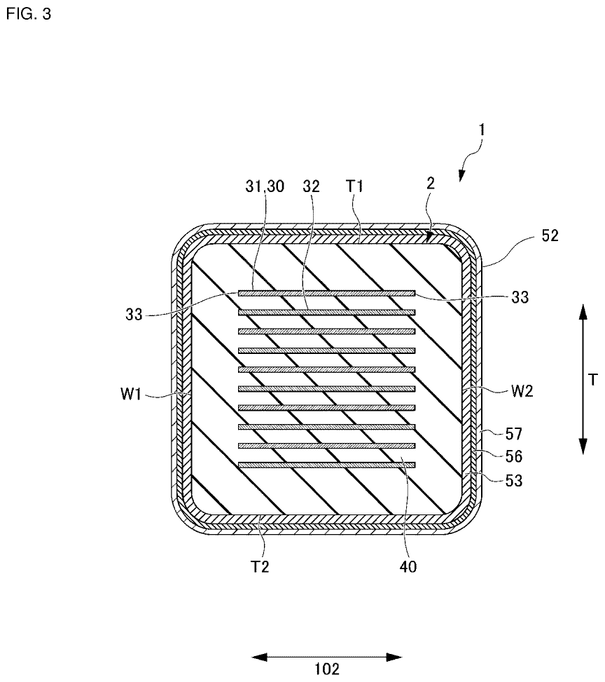

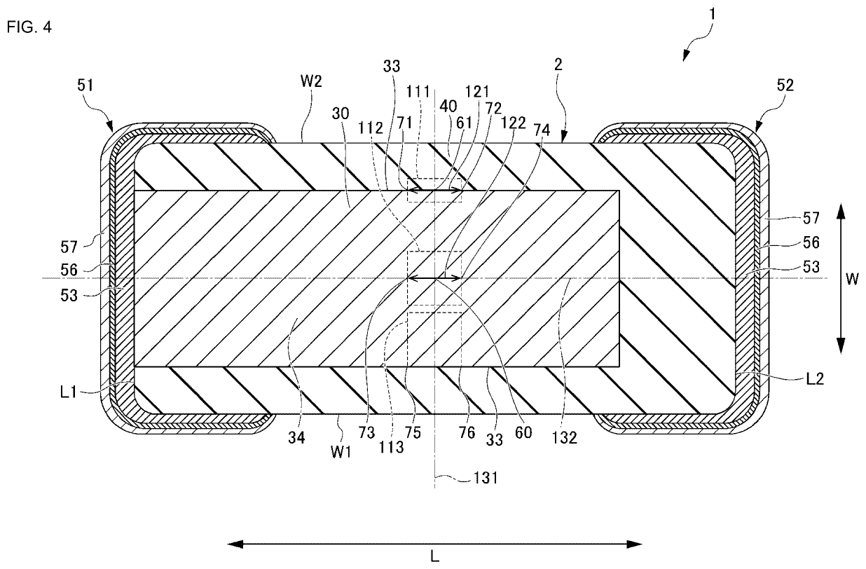

FIG. 2 is a cross-sectional view taken along Line 201-201 in FIG. 1. FIG. 3 is a cross-sectional view taken along Line 202-202 in FIG. 1. FIG. 4 is a cross-sectional view taken along Line 203-203 in FIG. 1. As illustrated in FIGS. 2 and 3, the multilayer body 2 includes an inner electrode layer 30 and a dielectric layer 40. Multiple inner electrode layers 30 and multiple dielectric layers 40 are included in the multilayer body 2. The inner electrode layers 30 and the dielectric layers 40 are laminated alternately.

The multilayer body 2 is shaped like a cuboid. The direction in which the inner electrode layers 30 and the dielectric layers 40 are laminated is referred to as the lamination direction T. One of the directions orthogonally intersecting the lamination direction T is referred to as the length direction L. The direction orthogonally intersecting the lamination direction T and the length direction L is referred to as the width direction W.

A cross section of the multilayer body extending in the length direction L and in the lamination direction T is referred to as an LT cross section. FIG. 2 illustrates an LT cross section. A cross section of the multilayer body extending in the width direction W and in the lamination direction T is referred to as an WT cross section. FIG. 3 illustrates a WT cross section. A cross section of the multilayer body extending in the length direction L and in the width direction W is referred to as an LW cross section. FIG. 4 illustrates an LW cross section.

Two surfaces of the multilayer body that face oppositely in the lamination direction T are a first principal surface T1 and a second principal surface T2. Two surfaces of the multilayer body that face oppositely in the width direction W are a first side surface W1 and a second side surface W2. Two surfaces of the multilayer body that face oppositely in the length direction L are a first end surface L1 and a second end surface L2.

The inner electrode layers 30 include a first inner electrode layer 31 and a second inner electrode layer 32. The first inner electrode layer 31 is an inner electrode layer 30 extended out onto the first end surface L1. The second inner electrode layer 32 is an inner electrode layer 30 extended out onto the second end surface L2. FIG. 4 illustrates the first inner electrode layer 31.

The inner electrode layer 30 includes copper as a main ingredient. The inner electrode layer 30 may include metals other than copper.

The total number of the inner electrode layers 30 equals to the sum of the number of the first inner electrode layers 31 and the number of the second inner electrode layers 32. The total number of the inner electrode layers 30 is preferably 2 or more and 30 or less, for example.

The dielectric layer 40 includes at least one of a titanium oxide (TiO₂) and a ceramic material as a main ingredient. The general formula of the ceramic material is (Ca_{1-x-y}, Srₓ, Ba_{y})ₘ(Zr_{1-z-α}, Ti_{z})O₃ (where x is about 0 or more and about 1 or less, y is about 0 or more and about 0.4 or less, m is about 1.0 or more and about 1.1 or less, z is about 0 or more and about 0.2 or less, and α is about 0 or more and about 0.3 or less, for example, within manufacturing and measurement tolerances. For example, the ceramic material having the above general formula is calcium zirconate (CaZrO₃). Additives may be added to the above main ingredient for intended purposes. For example, such additives include Mn, Mg, Dy, Cr, or oxides of rare earth elements, such as V, Sm, Eu, Gd, Tb, Ho, Er, Tm, Yb, or Y, or oxides of Co, Ni, Li, B, Na, K, or Si, or glass.

A preferable thickness of a portion of the dielectric layer 40, the portion being sandwiched by the first inner electrode layer 31 and the second inner electrode layer 32 in the lamination direction T, is about 0.3 μm or more and 20 μm or less for example, within manufacturing and measurement tolerances.

The size of the multilayer body 2 is not specifically limited. A preferable dimension of the multilayer body 2 in the length direction L is about 0.2 mm or more and about 10 mm or less, for example, within manufacturing and measurement tolerances. A preferable dimension of the multilayer body 2 in the width direction W is about 0.1 mm or more and about 5 mm or less, for example, within manufacturing and measurement tolerances. A preferable dimension of the multilayer body 2 in the lamination direction T is about 0.1 mm or more and about 5 mm or less, for example, within manufacturing and measurement tolerances.

The outer electrodes 50 include the first outer electrode 51 and the second outer electrode 52. The first outer electrode 51 is an outer electrode 50 connected to the first inner electrode layers 31. The second outer electrode 52 is an outer electrode 50 connected to the second inner electrode layers 32.

The first outer electrode 51 is disposed on the first end surface L1, a portion of the first principal surface T1, a portion of the second principal surface T2, a portion of the first side surface W1, and a portion of the second side surface W2. The second outer electrode 52 is disposed on the second end surface L2, a portion of the first principal surface T1, a portion of the second principal surface T2, a portion of the first side surface W1, and a portion of the second side surface W2.

Each outer electrode 50 includes a base electrode layer 53 and plating layers 55. The plating layers 55 include a nickel plating layer 56 and a tin plating layer 57. The base electrode layer 53, the nickel plating layer 56, and the tin plating layer 57 are formed in this order from each end surface of the multilayer body 2.

The base electrode layer 53 includes metal and glass. Examples of the metal is copper, nickel, silver, palladium, silver-palladium alloy, and gold. Examples of the glass is boron-based glass and silicon-based glass. The base electrode layer 53 is formed by baking an electroconductive paste. The electroconductive paste includes metal and glass. The electroconductive paste is applied onto the multilayer body 2 and then baked. The thickness of the base electrode layer 53 is preferably about 3 μm or more and about 100 μm or less, for example, within manufacturing and measurement tolerances.

The nickel plating layer 56 is disposed so as to cover the base electrode layer 53. The tin plating layer 57 is disposed so as to cover the nickel plating layer 56.

The multilayer ceramic capacitor 1 is mounted onto a circuit board using solder. The nickel plating layer 56 prevents solder from eroding the base electrode layer 53. The tin plating layer 57 improves solder's wettability on the multilayer ceramic capacitor 1. The tin plating layer 57 thereby facilitates the mounting of the multilayer ceramic capacitor 1 onto the circuit board.

The size of the multilayer ceramic capacitor 1 is not specifically limited. A preferable dimension of the multilayer ceramic capacitor 1 in the length direction L, which includes the multilayer body 2 and the outer electrodes 50, is about 0.2 mm or more and about 10 mm or less, for example, within manufacturing and measurement tolerances. A preferable dimension of the multilayer ceramic capacitor 1 in the lamination direction T including the multilayer body 2 and the outer electrodes 50 is about 0.1 mm or more and about 5 mm or less, for example, within manufacturing and measurement tolerances. A preferable dimension of the multilayer ceramic capacitor 1 in the width direction W including the multilayer body 2 and the outer electrodes 50 is about 0.1 mm or more and about 10 mm or less, for example, within manufacturing and measurement tolerances.

In the present example embodiment, the inner electrode layer 30 of the multilayer ceramic capacitor 1 includes opposite end portions 33 positioned in the width direction W, and the linearity of the end portions 33 is as follows. As illustrated in FIG. 4, the end portions 33 of the inner electrode layer 30 positioned in the width direction W are side portions that oppose the first side surface W1 and the second side surface W2, respectively. In the multilayer ceramic capacitor 1 of the present example embodiment, the end portions 33 of the inner electrode layer 30 positioned in the width direction W have high linearity.

FIG. 4 illustrates a lengthwise-center line 131 that is a line passing through a center of the multilayer body 2, the center being defined in the length direction L. A widthwise-center line 132 that is a line passing through a center of the multilayer body 2, the center being defined in the width direction W. A middle position 60 is a middle position of the multilayer body 2 in the length direction L and the width direction W. The middle position 60 is positioned at the intersection of the lengthwise-center line 131 and the widthwise-center line 132. A first position 71 and a second position 72 are positioned on respective end portions 33 of the inner electrode layer 30 positioned in the width direction W. The midpoint between the first position 71 and the second position 72 is positioned on the lengthwise-center line 131.

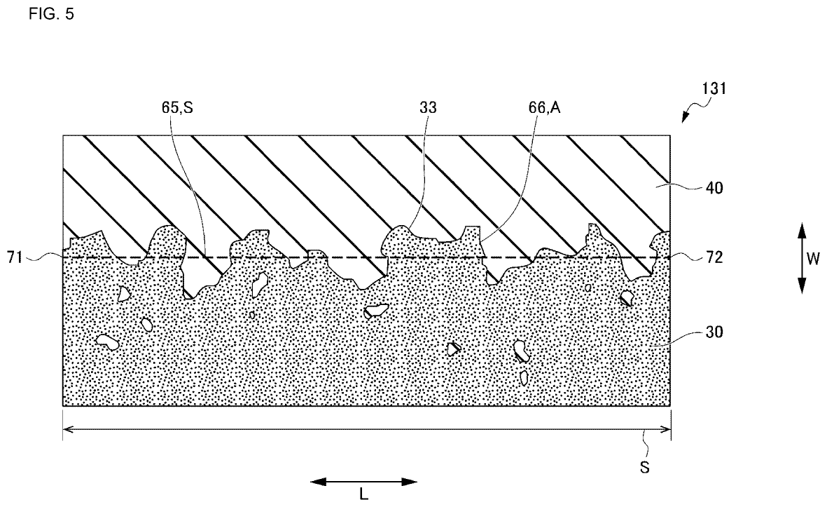

A first line segment 121 is a line segment connecting the first position 71 and the second position 72. A length S is the length of the first line segment 121. More specifically, the length S is defined in the following manner. The shape of the inner electrode layer 30 can be regarded as a polygon as viewed in the lamination direction T. When the inner electrode layer 30 is a polygon, the boundary between the inner electrode layer 30 and the dielectric layer 40 is defined by straight lines. The shape of the inner electrode layer 30 illustrated in FIG. 4 can be regarded as a rectangle, which is a type of polygon. The boundary between the inner electrode layer 30 and the dielectric layer 40 is defined by substantially straight lines. FIG. 5 is an enlarged view illustrating a first enclosed area 111 of FIG. 4. In FIG. 5, the broken line 65 is a boundary when the boundary is regarded as a straight line. The length S is the length of the broken line 65. The length of the broken line 65 is equal to the length of the first line segment 121 in FIG. 4.

The solid line 66 in FIG. 5 is an actual boundary between the inner electrode layer 30 and the dielectric layer 40. The actual boundary 66 is not a straight line as viewed in plan in the lamination direction T. The length A is the length of the actual boundary 66.

If the actual boundary 66 between the inner electrode layer 30 and the dielectric layer 40 is straight, the length A is equal to the length S. The length A becomes longer than the length S in cases except for the case in which the actual boundary 66 between the inner electrode layer 30 and the dielectric layer 40 is a straight line. The ratio of the length A to the length S is normally greater than about 1.0, for example, within manufacturing and measurement tolerances. The ratio of the length A to the length S indicates the linearity of the end portion 33 of the inner electrode layer 30. If the ratio of the length A to the length S comes closer to 1, the linearity improves. If the ratio of the length A to the length S becomes greater, the linearity is aggravated. In the present example embodiment, the ratio of the length A to the length S of the multilayer ceramic capacitor 1 is about 1.7 or less, for example, within manufacturing and measurement tolerances.

When the multilayer ceramic capacitor 1 is used in a high-frequency region, the current predominantly flows near the surfaces of the inner electrode layer 30. The predominant flow of the current near the surfaces of the inner electrode layer 30 is due to the skin effect. The flow of current concentrates along the actual boundary 66 between the inner electrode layer 30 and the dielectric layer 40. When the length A (i.e., the length of the actual boundary 66) is long, the resistance increases. When the resistance increases, the equivalent series resistance (ESR) per a unit inner electrode layer increases. The length A is preferably small. When the ratio of the length A to the length S is about 1.7 or less, for example, within manufacturing and measurement tolerances, the ESR per a unit electrode layer of the multilayer ceramic capacitor 1 decreases in a high-frequency region.

For example, the relationship between the ratio of the length A to the length S and the ESR (Ω) per one inner electrode layer at 1 GHz is such that the ESR for the case of the ratio of the length A to the length S being about 1.7 was about 78% of that for the case of the ratio of the length A to the length S being about 2.4, for example, within manufacturing and measurement tolerances. In other words, the reduction of the ratio of the length A to the length S from about 2.4 to about 1.7 caused an about 28% reduction in ESR, for example, within manufacturing and measurement tolerances. Note that the above measurements were conducted using the multilayer ceramic capacitor 1.

The ratio of the length A to the length S can be measured as below. The length A and the length S are determined using the same cross-sectional image. A principal surface of the multilayer ceramic capacitor 1 is ground. An LW cross section of the inner electrode layer 30 is thereby exposed. An enlarged view of the portion corresponding to the first line segment 121 of the end portion 33 of the inner electrode layer 30 is obtained using an electron microscope, and the length A is measured. When the length A is measured, the length of the first line segment 121 is about 80 μm, for example, within manufacturing and measurement tolerances. In other words, the length S is about 80 μm. The magnification for the observation is 2000×.

In the multilayer ceramic capacitor 1 of the present example embodiment, the thickness of the end portion 33 of the inner electrode layer 30 positioned in the width direction W is as follows. In the multilayer ceramic capacitor 1 of the present example embodiment, the thickness of the end portion 33 of the inner electrode layer 30 positioned in the width direction W is large. The thickness of the end portion 33 of the inner electrode layer 30 positioned in the width direction W is about 1.4 μm or more, for example, within manufacturing and measurement tolerances.

For example, one method of improving the linearity of the end portion 33 of the inner electrode layer 30 is to increase the thickness of the end portion 33 of the inner electrode layer 30 positioned in the width direction W. For example, when the thickness of the end portion 33 of the inner electrode layer 30 positioned in the width direction W is increased to a predetermined thickness or more, the ratio of the length A to the length S can be reduced to a predetermined value or less. In other words, as the thickness of the end portion 33 of the inner electrode layer 30 positioned in the width direction W increases, the linearity of the end portion 33 of the inner electrode layer 30 improves. More specifically, for example, the ratio of the length A to the length S can be decreased to about 1.7 or less by increasing the thickness of the end portion 33 of the inner electrode layer 30 positioned in the width direction W to about 1.4 μm or more, for example, within manufacturing and measurement tolerances.

The thickness of the end portion 33 of the inner electrode layer 30 positioned in the width direction W can be measured as below. In FIG. 4, an end-portion's middle position 61 is positioned at the intersection of the lengthwise-center line 131 and the end portion 33 of the inner electrode layer 30. The thickness of the inner electrode layer 30 is measured at the end-portion's middle position 61. A side surface of the multilayer ceramic capacitor 1 is ground. An LT cross section of the inner electrode layer 30 is thereby exposed. An enlarged view at the end-portion's middle position 61 is obtained using an electron microscope, and the thickness of the inner electrode layer 30 is measured. The magnification for the observation is 2000×.

The measurement of the ratio of the length A to the length S (i.e., the measurement of the linearity) and the measurement of the thickness of the end portion 33 of the inner electrode layer 30 positioned in the width direction W can be conducted in sequence with the linearity measurement being first and the thickness measurement being next. In this case, a principal surface of the multilayer ceramic capacitor 1 is ground first. An LW cross section of the inner electrode layer 30 is thereby exposed to measure the length A and the length S. Subsequently, a side surface of the multilayer ceramic capacitor 1 is ground. An LT cross section of the inner electrode layer 30 is thereby exposed to measure the thickness of the inner electrode layer 30.

The following describes a coverage of the inner electrode layer 30 in the multilayer ceramic capacitor 1 of the present example embodiment. As illustrated in FIG. 4, a middle portion 34 of the inner electrode layer 30 is positioned over the widthwise-center line 132. The middle portion 34 of the inner electrode layer 30 is a portion located in the middle in the width direction W. In the multilayer ceramic capacitor 1 of the present example embodiment, the coverage of the end portion 33 of the inner electrode layer 30 positioned in the width direction W is greater than the coverage of the middle portion 34 of the inner electrode layer 30 positioned in the width direction W. The above coverage includes a linear coverage and an areal coverage. In at least one of the linear coverage and the areal coverage, the coverage of the end portion 33 of the inner electrode layer 30 positioned in the width direction W is greater than the coverage of the middle portion 34 of the inner electrode layer 30 positioned in the width direction W.

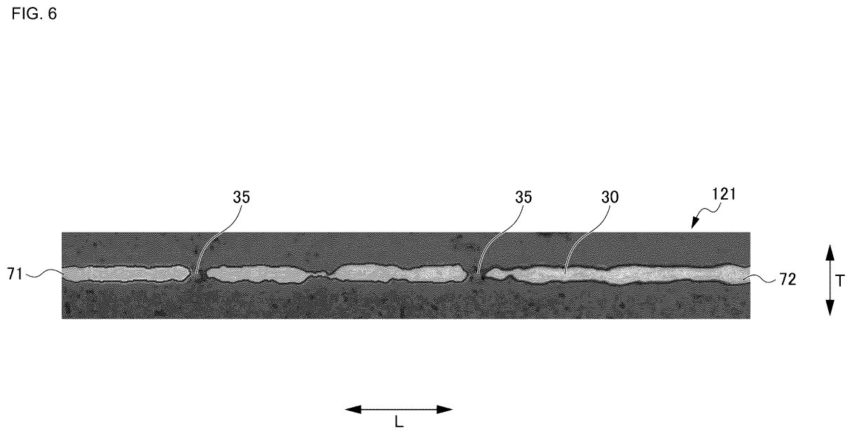

The linear coverage is a coverage measured on the LT cross section of the inner electrode layer 30. When the LT cross section is observed, the cross section of the inner electrode layer 30 can be regarded as a line. The linear coverage is a ratio of metal occupying in the inner electrode layer 30 that is regarded as a line. More specifically, a ratio of a total length of portions except for discontinuous portions 35 to a total length of a predetermined line segment is calculated. The ratio obtained as above is the linear coverage. FIG. 6 illustrates an LT cross section of the end portion 33 of the inner electrode layer 30 positioned in the width direction W. As illustrated in FIG. 6, the discontinuous portions 35 are portions that divide the inner electrode layer 30. The linear coverage of the end portion 33 of the inner electrode layer 30 positioned in the width direction W is greater than the linear coverage of the middle portion 34 of the inner electrode layer 30 positioned in the width direction W.

The linear coverage of the end portion 33 of the inner electrode layer 30 positioned in the width direction W can be measured as below. A side surface of the multilayer body 2 is ground to expose an LT cross section of the end portion 33 of the inner electrode layer 30. In the LT cross section exposed, a portion corresponding to the first line segment 121 of the inner electrode layer 30 is observed using an electron microscope. The position of the first line segment 121 has already been described with reference to FIG. 4. The linear coverage of the inner electrode layer 30 is calculated at the position corresponding to the first line segment 121.

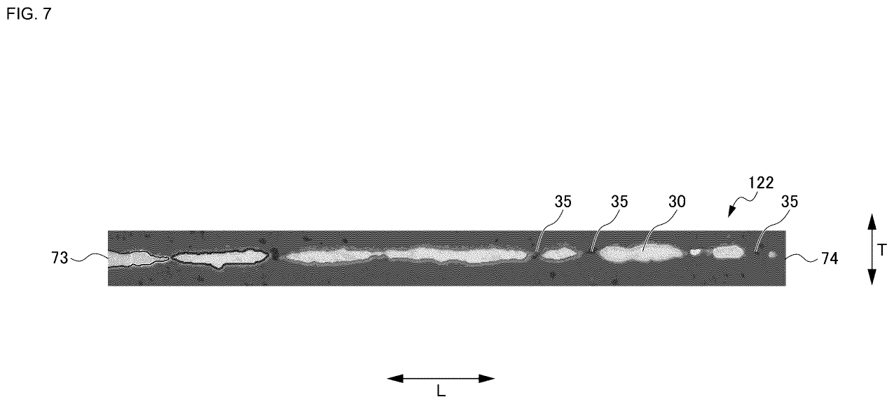

The linear coverage of the middle portion 34 of the inner electrode layer 30 positioned in the width direction W can be measured as below. The linear coverage of the end portion 33 of the inner electrode layer 30 positioned in the width direction W is measured at the position corresponding to the first line segment 121. On the other hand, the linear coverage of the middle portion 34 of the inner electrode layer 30 positioned in the width direction W is measured at a position corresponding to a second line segment 122, which is shown in FIG. 4. The second line segment 122 is a line segment connecting a third position 73 and a fourth position 74. The second line segment 122 is positioned on the widthwise-center line 132. The length of second line segment 122 is equal to the length of the first line segment 121. In the length direction L, the position of the second line segment 122 is the same as the position of the first line segment 121. In the length direction L, the third position 73 is located at the same position of the first position 71. In the length direction L, the fourth position 74 is located at the same position of the second position 72. The multilayer body 2 is ground to expose the LT cross section of the inner electrode layer 30 at the center line 132 that passes through the center positioned in the width direction W. FIG. 7 illustrates the LT cross section of the middle portion 34 of the inner electrode layer 30 positioned in the width direction W. A portion corresponding to the second line segment 122 of the inner electrode layer 30 is observed using an electron microscope to determine the linear coverage.

The linear coverage of the end portion 33 of the inner electrode layer 30 positioned in the width direction W is greater than the linear coverage of the middle portion 34 of the inner electrode layer 30 positioned in the width direction W.

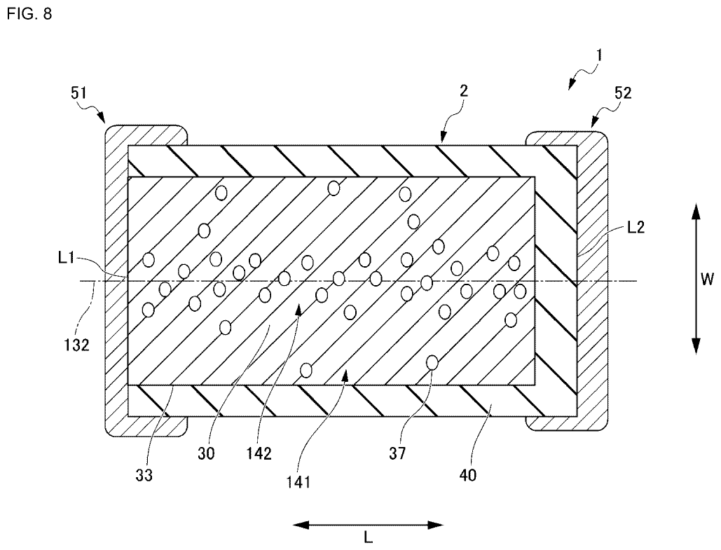

The areal coverage is a coverage to be measured with the inner electrode layer 30 being viewed in the lamination direction T. An LW surface is a surface to be observed as viewed in plan in the lamination direction T. The inner electrode layer 30, of which the LW surface is observed, can be regarded as an areal object. The areal coverage is a ratio of metal occupying in the inner electrode layer 30, which is regarded as an areal object. FIG. 8 illustrates the LW surface of the multilayer ceramic capacitor 1. In FIG. 8, voids 37 are holes extending through the inner electrode layer 30. The metallic material of the inner electrode layer 30 is not present in the voids 37. The areal coverage is a ratio of an area excluding the voids 37 in a predetermined area of the inner electrode layer 30 to the entire predetermined area. The areal coverage can be determined by counting the number of pixels included in an image through image processing. More specifically, the areal coverage is a ratio of the number of pixels of the portion other than the voids 37 to the total number of pixels of the inner electrode layer 30 being observed. The areal coverage in the vicinity of the end portion 33 of the inner electrode layer 30 positioned in the width direction W is greater than the areal coverage of the middle portion 34 of the inner electrode layer 30 positioned in the width direction W. In the areal coverage, the coverage of the end portion 33 of the inner electrode layer 30 positioned in the width direction W means the coverage measured in a predetermined region that includes the end portion 33. In the areal coverage, the coverage of middle portion 34 of the inner electrode layer 30 positioned in the width direction W means the coverage measured in a predetermined region that includes the middle portion 34.

The areal coverage of the end portion 33 of the inner electrode layer 30 positioned in the width direction W can be measured as below. In the multilayer body 2, the dielectric layer 40 is peeled off from an inner electrode layer 30 to be exposed. The LW surface of the inner electrode layer 30 is thereby exposed to measure the areal coverage as described above.

A third enclosed area 113 is shaped like a square. The length of each side of the third enclosed area 113 is about 10 μm, for example, within manufacturing and measurement tolerances. One side of the third enclosed area 113 is positioned on the end portion 33 of the inner electrode layer 30 positioned in the width direction W. The third enclosed area 113 itself is positioned at the center in the length direction L. A fifth position 75 is located at one of the corners of the third enclosed area 113, the one being positioned on the end portion 33. A sixth position 76 is located at the other one of the corners of the third enclosed area 113, the other one being positioned on the end portion 33. The midpoint between the fifth position 75 and the sixth position 76 is positioned on the lengthwise-center line 131.

The areal coverage of the middle portion 34 of the inner electrode layer 30 positioned in the width direction W can be measured as below. The following description focuses on the difference from the method of measuring the areal coverage of the end portion 33. Items not covered below are the same as those for measuring the areal coverage of the end portion 33. The areal coverage of the end portion 33 is measured in the third enclosed area 113. On the other hand, the areal coverage of the middle portion 34 of the inner electrode layer 30 positioned in the width direction W is measured in a second enclosed area 112.

FIG. 4 illustrates the second enclosed area 112. The second enclosed area 112 is shaped like a square. The length of each side of the second enclosed area 112 is about 10 μm, for example, within manufacturing and measurement tolerances. Two sides of the second enclosed area 112 extend in the length direction L. The other two sides of the second enclosed area 112 extend in the width direction W. The second enclosed area 112 is located at a middle position of the multilayer body 2. The intersection of the two diagonals of the second enclosed area 112 are located at the middle position 6 about 0 .

In the multilayer ceramic capacitor 1 of the present example embodiment, the areal coverage of the end portion 33 of the inner electrode layer 30 positioned in the width direction W is greater than the areal coverage of the middle portion 34 of the inner electrode layer 30 positioned in the width direction W. In FIG. 8, an end region 141 is a region located in the vicinity of the end portion 33 of the inner electrode layer 30 positioned in the width direction W. In FIG. 8, a central region 142 is a region located in the vicinity of the middle portion 34 of the inner electrode layer 30 positioned in the width direction W. FIG. 8 illustrates a schematic distribution image of the voids 37 in the inner electrode layer 30. Note that the voids 37 illustrated in FIG. 8 are not real ones that actually exist. As illustrated in FIG. 8, the distribution density of the voids 37 in the end region 141 is smaller than the distribution density of the voids 37 in the central region 142.

In the multilayer ceramic capacitor 1 of the present example embodiment, the coverage of the end portion 33 of the inner electrode layer 30 positioned in the width direction W is greater than the coverage of the middle portion 34 of the inner electrode layer 30 positioned in the width direction W. This reduces the resistance of the end portion 33 of the inner electrode layer 30 positioned in the width direction W. As a result, the multilayer ceramic capacitor 1 according to an example embodiment of the present invention achieves a high Q-value.

The following describes the diameters of copper particles included in the inner electrode layer 30 of the multilayer ceramic capacitor 1 of the present example embodiment. In the multilayer ceramic capacitor 1 of the present example embodiment, an average particle diameter of copper included in the inner electrode layer 30 is about 2.2 μm or more, for example, within manufacturing and measurement tolerances. As a result of that the average particle diameter of copper included in the inner electrode layer 30 is about 2.2 μm or more in the multilayer ceramic capacitor 1 of the present example embodiment, the resistance of the inner electrode layer 30 is decreased.

The average particle diameter of copper included in the inner electrode layer 30 can be determined by observing an LT cross section of the inner electrode layer 30 using a scanning ion microscope (SIM) with focused ion beams (FIB).

The multilayer ceramic capacitor 1 of the present example embodiment simultaneously has the above-described characteristics of the linearity, the thickness, and the coverage of the end portion 33 of the inner electrode layer 30 positioned in the width direction W as well as of the average particle diameter of copper. As a result, the multilayer ceramic capacitor 1 according to the present example embodiment provides a high Q-value.

The following describes a non-limiting example of a method of manufacturing the multilayer ceramic capacitor 1.
(1) An electroconductive paste for the inner electrode layer 30 and a dielectric sheet are prepared.

The dielectric sheet and the electroconductive paste include a binder and a solvent. The binder and the solvent may be a known organic binder and a known organic solvent.
(2) The electroconductive paste for the inner electrode layer 30 is applied onto the dielectric sheet to print a predetermined pattern. In other words, the inner electrode layer is patterned on the dielectric sheet. Examples methods of printing include a screen printing and a gravure printing.
(3) A predetermined number of dielectric sheets on which no inner electrode layer is patterned are laminated. Subsequently, a predetermined number of dielectric sheets on which the inner electrode layer is patterned are laminated thereon. A predetermined number of dielectric sheets on which no inner electrode layer is patterned are further laminated thereon.
(4) The laminated sheets are pressed in the lamination direction. An example method of pressing is isostatic pressing. The laminated sheets become multilayer blocks after pressing.
(5) The multilayer blocks are baked to become the multilayer bodies 2. In the multilayer ceramic capacitor 1 of the present example embodiment, the baking temperature is about 980° C. or more and about 1020° C. or less.
(6) The outer electrodes 50 are formed on respective two end surfaces of each multilayer body 2. A known method may be used for forming the outer electrodes 50. For example, an electroconductive paste containing an electroconductive material as a main ingredient, such as copper or nickel, is applied onto the end surfaces and then baked to form the base layer's electrode layers 54. The base layer's electrode layers 54 may be formed by applying the electroconductive paste to an unbaked form of the multilayer body 2 and then baking it. After forming the base electrode layer 53, the nickel plating layer 56 and the tin plating layer 57 are formed on the surface of the base electrode layer 53 by electrolytic plating. The multilayer ceramic capacitor is thus manufactured.

Example embodiments of the present invention have been described. The present invention, however, is not limited to the above example embodiments and includes various alterations and modifications.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body in which multiple dielectric layers and multiple inner electrode layers are laminated in a lamination direction; wherein
the dielectric layers include at least one of TiO₂ and (Ca_{1-x-y}, Srₓ, Ba_{y})ₘ(Zr_{1-z-α}, Ti_{z})O₃, where x is about 0 or more and about 1 or less, y is about 0 or more and about 0.4 or less, m is about 1.0 or more and about 1.1 or less, z is about 0 or more and about 0.2 or less, and α is about 0 or more and about 0.3 or less;
when the multilayer body is cut along a cross section extending orthogonal to the lamination direction, the inner electrode layer includes widthwise end portions facing oppositely in a width direction of the inner electrode layer;
when a shape of the inner electrode layer is regarded as a polygon as viewed in plan in the lamination direction and S denotes a length of a boundary defined by straight lines between the inner electrode layer and a dielectric layer and when A denotes a length of an actual boundary between the inner electrode layer and the dielectric layer, a ratio of the length A to the length S is about 1.7 or less;
a thickness of a widthwise end portion of the inner electrode layer is about 1.2 μm or more;
a coverage of the widthwise end portion of the inner electrode layer is greater than a coverage of a widthwise middle portion of the inner electrode layer; and
an average particle diameter of copper included in the inner electrode layer is about 2.2 μm or more.

2. The multilayer ceramic capacitor according to claim 1, wherein, when the multilayer body is cut along a plane extending in the lamination direction and an exposed cross section of the inner electrode layer is observed, the coverage is evaluated based on a number of discontinuous portions of the inner electrode layer with respect to a predetermined length of the inner electrode layer.

3. The multilayer ceramic capacitor according to claim 1, wherein when the inner electrode layer is observed in the lamination direction, the coverage is evaluated based on a number of voids present in the inner electrode layer within a predetermined area.

4. The multilayer ceramic capacitor according to claim 1, wherein the multilayer body has a cuboid shape.

5. The multilayer ceramic capacitor according to claim 1, wherein the dielectric layers include calcium zirconate.

6. The multilayer ceramic capacitor according to claim 5, wherein the dielectric layers further include Mn, Mg, Dy, Cr, or oxides of rare earth elements including V, Sm, Eu, Gd, Tb, Ho, Er, Tm, Yb, or Y, or oxides of Co, Ni, Li, B, Na, K, or Si, or glass.

7. The multilayer ceramic capacitor according to claim 1, wherein a thickness of a portion of one of the dielectric layers sandwiched between a pair of the inner electrode layers is about 0.3 μm or more and 20 μm or less.

8. The multilayer ceramic capacitor according to claim 1, wherein the multilayer body has a dimension in a length direction of about 0.2 mm or more and about 10 mm or less, a dimension in the width direction of about 0.1 mm or more and about 5 mm or less, and a dimension in the lamination direction of about 0.1 mm or more and about 5 mm or less.

9. The multilayer ceramic capacitor according to claim 1, further comprising first and second outer electrodes on the multilayer body and including a base electrode layer and a plating layer.

10. The multilayer ceramic capacitor according to claim 9, wherein the plating layer includes a nickel plating layer and a tin plating layer.

11. The multilayer ceramic capacitor according to claim 1, wherein the multilayer ceramic capacitor has a dimension in a length direction of about 0.2 mm or more and about 10 mm or less, a dimension in the width direction of about 0.1 mm or more and about 5 mm or less, and a dimension in the lamination direction of about 0.1 mm or more and about 10 mm or less.

12. The multilayer ceramic capacitor according to claim 1, wherein the ratio of the length A to the length S is about 1.0 to about 1.7.

13. The multilayer ceramic capacitor according to claim 1, wherein the length S is about 80 μm.

14. The multilayer ceramic capacitor according to claim 1, wherein the thickness of the widthwise end portion of the inner electrode layer is about 1.4 μm or more.
